(19) United States
(12) Patent Application Publication
(10) Pub. No.: US 2003/0136062 A1
(43) Pub. Date: Jul. 24, 2003

(54) Rapid deployment methodology

(76) Inventor: Ray Gunthardt, Tempe, AZ (US)

Correspondence Address: Ray Gunthardt, 1915 E. Loyola Dr., Tempe, AZ, 85282, US

(21) Appl. No.: 10/349,337

(22) Filed: Jan. 21, 2003

Related U.S. Application Data
(60) Provisional application No. 60/351,233, filed on Jan. 23, 2002.

(51) Int. Cl. B66C 23/26

(52) U.S. Cl. 52/120; 52/741.14; 52/123.1; 52/125.6

(57) ABSTRACT

The Rapid Deployment Methodology for Architecture is in essence a streamlined building or production process, especially for tall architecture or large projects. It eliminates unnecessary delays and procedures, therefore boosting efficiency.

Advanced manufacturing of spatial elements, such as floors and walls, potentially combined into partial or complete modules or elements, increased lifting capacities for loads, and advantageous erecting of the framework, result in strategically advanced methods of building architectures.

The resulting architectures are stronger, and more resilient against a variety of stresses and loads, because the components reinforce the framework.

Depending on complexity, designs of components and many other factors and variables, the invention will dramatically reduce time and cost to build and complete architectures. Sophisticated structural monitoring and warning systems can be installed, and measure deflections, temperatures and various additional parameters.

### CROSS-REFERENCE TO RELATED APPLICATIONS

This application is related to prior Application No. 60/351,233 filed on: Jan. 23, 2002

### FIELD OF THE INVENTION

This invention relates to architecture. In a more specific aspect, the instant invention relates to an advanced, streamlined, economical and accelerated method of building architectures.

### BACKGROUND OF THE INVENTION

A solid foundation is required to secure any superstructure. The superstructure consists of two main components: a framework or chassis usually made of steel, and the concrete supported by the steel framework.

Even modern skyscrapers can have a superstructure where less than 10% of its mass is made of steel, supporting over 90% of concrete. The concrete is used for the walls and floors. Because of the un-satisfying mechanical properties of concrete, especially the floors become very thick and heavy—even when they are supported and reinforced. [Petronas Twin Towers in Kuala Lumpur, Asia (approximation): Steel: 36,910 tons of beams, trusses and reinforcements, verses Concrete (160,000 cubic meters in the superstructure, various strength up to grade 80):, estimated at 390,000 tons.

The Traditional Building Process of larger Structures is highly involved. Every concrete surface requires at least one form before the concrete can be poured one load after another, until the form is full. Now the concrete must solidify and cure to a minimal degree before the form can be removed, to be reassembled for the next surface. This time consuming process begins all over again. The higher the elevation of this process, the more time and effort is required.

The Danger Zone: Concrete is a great material for fire protection and pure compressive stress. The geometric designs of highway bridges, buildings and anything where concrete is used always emphasize one major concern: pure compression only. The reason: concrete is quite weak when exposed to tension, torsion or elasticity.

These potentially dangerous disadvantages became evident by the collapse of the Twin Towers: The massive hole in each tower destroyed and weakened a large portion of the structural support for all floors above the impact zones. This severely weakened steel chassis was still strong enough to support that mass of thousands of tons above. Several minutes of infernal heat weakened that chassis. The top stories fell, acting as a gigantic sledge hammer. This catastrophic impact could not be absorbed by the stories below. It collapsed while adding its mass to the momentum. The vicious cycle continued until it was finally stopped by the mighty foundation and solid rock.

The immense mass of concrete does not increase the structural integrity of superstructures, but acts as a dead mass, requiring a very strong and massive support structure, usually the framework.

Most or even all concrete can be replaced by elements that severely reduce the mass, while simultaneously increasing the mechanical integrity considerably. Consequently, the framework can be much lighter, while the overall resiliency and structural integrity is increased.

Further, the processes of manufacturing, transporting, assembling and installing the various components of superstructures could be streamlined for efficiency, while considerably increasing the qualities and potentials of the finished architectures in various aspects. This translates into reduced cost and time invested for en even better product.

Thus, there is a need for advanced and optimized methods of building, material combinations, economic considerations and strategically beneficial processes.

### BRIEF SUMMARY OF THE INVENTION

Replacing concrete with light, strong and resilient components, especially when combined with tough and proven materials, translates directly into drastically reduced weight to a fraction, with a sharp increase in mechanical properties and structural integrity. Fireproofing the components where required while boosting productivity sharply increases safety and efficiency.

The modules inserted into the framework could interlock with each other, the framework and the windows, while increasing the structural integrity of the superstructure.

Complementary methods to streamline manufacturing components, erection of the superstructure and all installed systems further reduce time, effort and cost. Careful selection of the combination of materials used can minimize or even eliminate concerns regarding thermal expansion differentials, issues regarding welding, corrosion, condensation and other aspects. The following example illustrates the basic concept, but is not limited to the specifics described.

### BRIEF DESCRIPTION OF THE DRAWINGS

Referring to the drawings:

FIG. 1 is a perspective overview of the construction process, in accordance with the invention.

FIG. 2 is side elevational view of load-relays shown in FIG. 1, in accordance with the invention.

FIG. 3 is a side elevational view of the Climb-Robot, in accordance with the invention.

FIG. 4 is a perspective view of the Climb-Robot, in accordance with the invention.

FIG. 5 is a perspective view of an insertion of an Element into the framework, in accordance with the invention.

FIG. 6 is a close-up view of an insertion of an Element, in accordance with the invention.

FIG. 7 is ta cut away view of a floor section, in accordance with the invention.

FIG. 8 is a close-up view of the assembly of an Element, in accordance with the invention.

FIG. 9 is a side elevational view of a cover, in accordance with the invention.

FIG. 10 is a close-up view of the securing of Elements, in accordance with the invention.

### DETAILED DESCRIPTION OF THE INVENTION

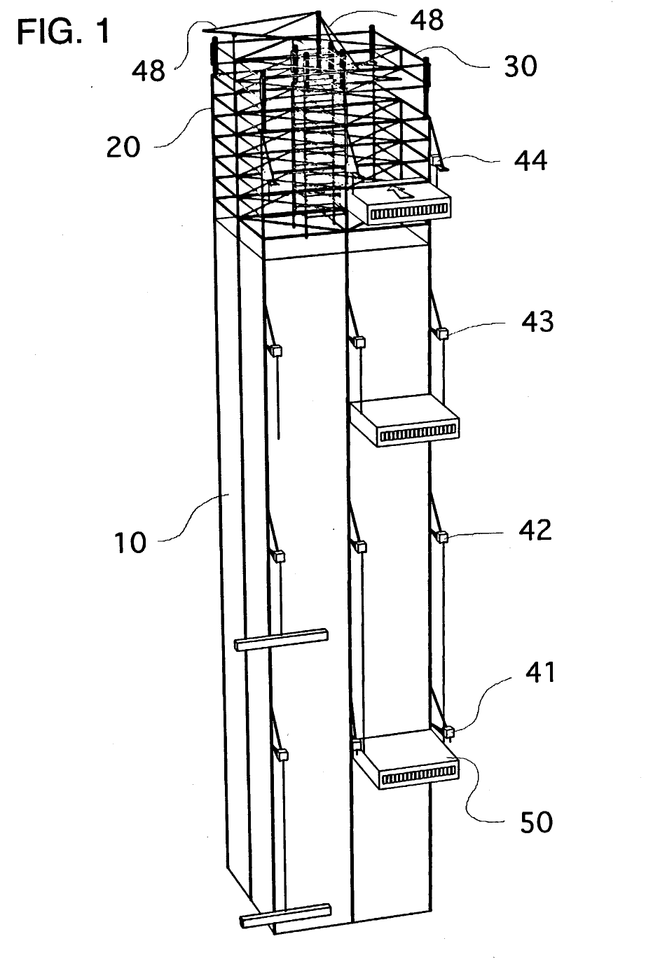

FIG. 1 is a perspective view of the superstructure during construction. The framework 20 is erected from the ground up in the definite arrangement of the members or components. The elements are firmly joined, preferably by welding. Level by level the framework is rising. The framework could employ a Climb-Robot 30 to constantly provide load lifting capabilities for the construction of the framework below by the cranes 48, regardless to the current height of the Climb-Robot.

When several crane-like devices are arranged in a vertical line, one above another, each transferring objects only a reasonable height, the number of objects lifted per hour would increase along with the maximal mass per object (compared to one crane lifting objects over a respectable height). The lowest relay-lifter 41 picks an object from the ground to its maximum height, the next relay-lifter 42 secures the load, then the lower lifter 41 releases, swings sideways to provide clearance, and begins to pick up the next object while the second relay-lifter 42 raises the object to its maximum height to transfer it to the third relay-lifter 43. This process continues until the object has reached the final destination. Several of these vertical arrays of relay-lifters can be placed per superstructure, depending on demand. Shorter cables translate into higher loads and more stability, and higher frequency because of shorter distances. Several relay-lifters located horizontally at the same height, and can simultaneously lift much larger and heavier objects, such as entire elements or modules 50, and transfer them in the same fashion.

Structural monitoring and sophisticated warning systems can be installed, since deflections, temperatures and various additional factors can be constantly measured and processed by computers.

FIG. 2 is a side elevational view of the details of the load-relays indicated in FIG. 1, and are explained in the corresponding paragraph above. After completion of the superstructure, these relay-lifters could be used by the window cleaning and maintenance crews. Alternatively, the relay-lifters could be removed, replaced or modified according to the required purposes and appearance.

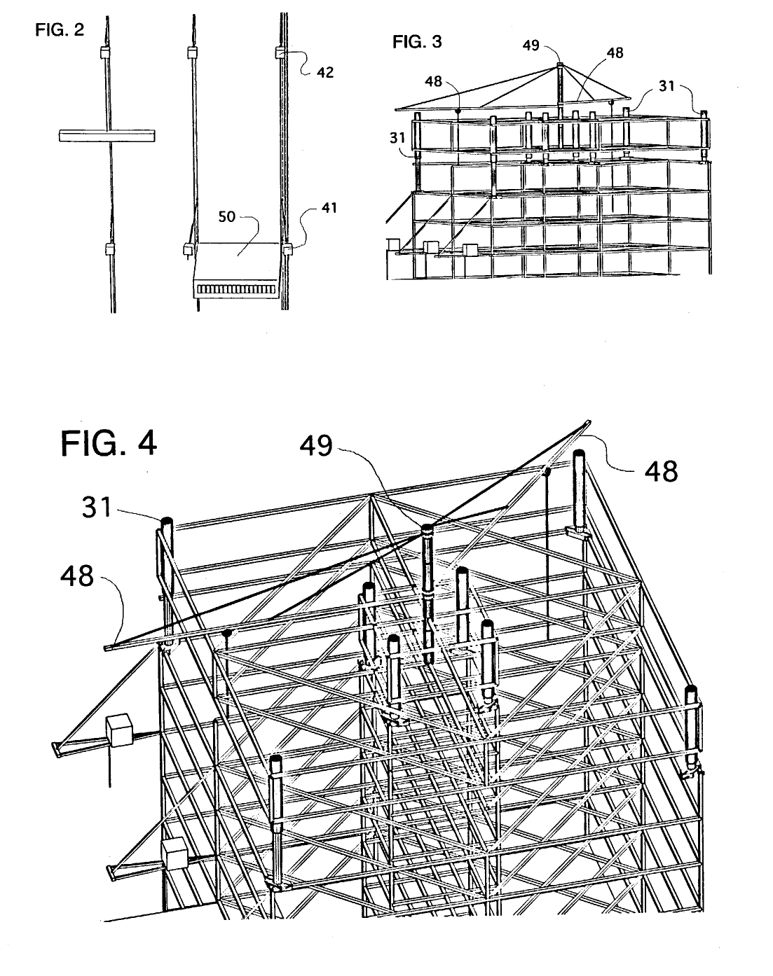

FIG. 3 is a side elevational view of the Climb-Robot. The Climb-Robot consists of several components with several lifters 31. The cranes 48, can swing separately, if desired about a common vertical rotational axis 49, and operate independently. The Climb-Robot is elevated by for example hydraulic presses 31. The vertical clearance between the Climb-Robot and the completed framework below provides the space required to add the next stage of the framework. Then the Climb-Robot is secured on the new top surface of the framework, the hydraulic mechanism secured to that new height, then the Climb-Robot is lifted again. This process is repeated until the framework is completed. The cranes 48 can assist in the insertion of elements and components, and hoist loads onto the Climb-Robot. Further, ironworkers can benefit from additional safety potentials provided.

Even further, the Climb-Robot can adapt to different width and/or shape to accommodate any geometric shape of the framework or architecture. After completion of the construction process, the Climb-Robot could be removed, replaced or modified according to the required purposes and appearance.

FIG. 4 is a perspective view of the Climb-Robot, as described under FIG. 3. The weight lifting capacity of these cranes 48 can be drastically increased when the crane arms are supported by a large diameter ring, mounted onto the top surface of the Climb-Robot, concentric with the rotational axis of the cranes, with radial wheels attached to each crane arm.

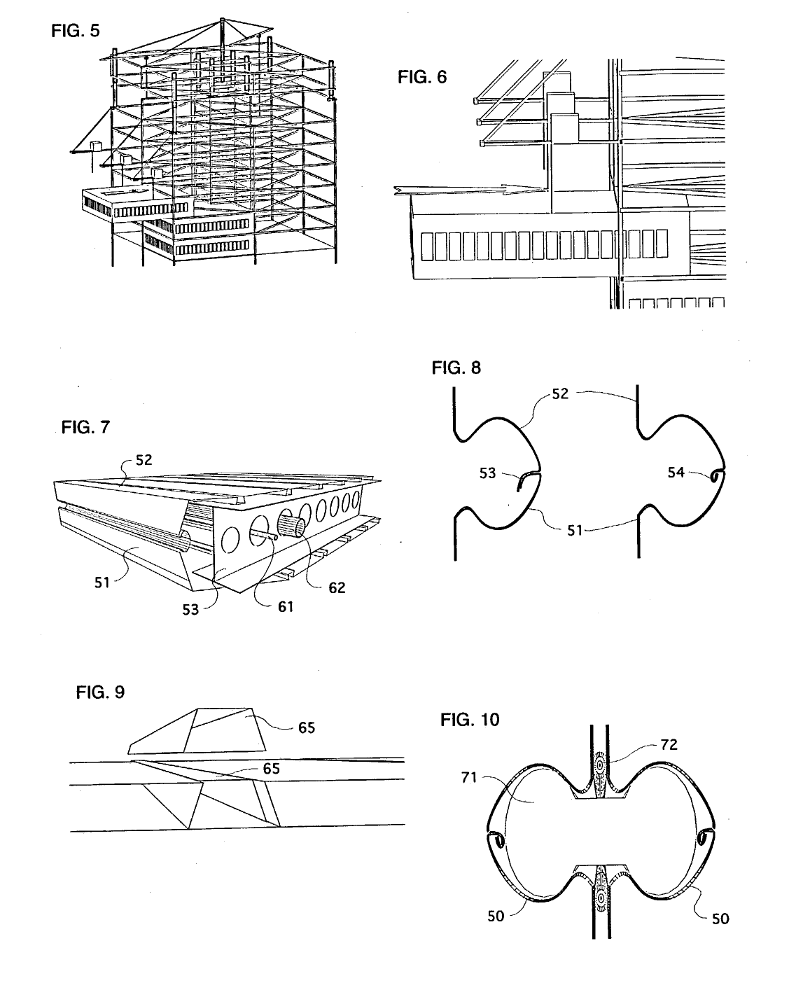

FIG. 5 is a perspective view of an insertion of an Element. The insertion process can be assisted by one or more cranes of the Climb-Robot, employing roller-brackets at the bottom of the element to roll along the beams of the framework, or by any other suitable method. The roller-brackets could be removed after the insertion to be used for the next element.

These modules can be manufactured from sheet metal, therefore they can function as fire protected cells or firewalls.

FIG. 6 is a close-up view of an insertion of an Element. Just a few stories below the current construction height of the framework, the finished modules or elements are inserted into the framework, completing the entire superstructure at that height, theoretically capable to start operations of the intended use of the offices, restaurants or any other type of business it may harbor. Only days after the framework is finished, the last modules or elements are inserted, the next day the entire skyscraper could start full operation in all aspects.

FIG. 7 is a perspective cut away view of a floor section. Several I-Beams 53 are positioned and firmly attached or welded into the first part or lower half 51 of the floor, wall or ceiling element or other segment. Plumbing pipes 62, conduits 61 and additional infrastructure can also be inserted into the elements, as desired. The second or top half 52 is placed onto the first half 51, then welded, point-welded or otherwise attached to the I-Beams 53. After processing the prefabricated parts to form complete elements or any components thereof, the hollow spaces can be filled by for example injecting a medium density foam into the properly positioned or tilted part, to ensure the absence of any air pockets. One suitable corner is elevated higher than all others, and strategically placed bleed holes first assist the escape of air, then are hermetically sealed.

The complete modules or elements 50, or suitable partitions, such as floors, walls, ceilings, or any combination thereof, can be manufactured or prepared on site on ground level. Conduits for electric wires, telephone, ethernet, plumbing and other infrastructural utility components can be integrated to any desired degree.

Immediately after the manufacturing process is complete, the parts are stored and allowed to cure, while the next part is made without delay. Then the parts are, where required, assembled to form entire elements, completed by installing the final floors, wires and infrastructure, cabinets, and any other components such as air condition and heating ducts. The prepared elements are then inserted into the final location of the framework. Now the elements are joined together and secured in the framework to gradually define entire sections or floors, the infrastructural components are connected, and only the areas of the connecting surfaces of the elements may need finishing touches.

Alternatively, some applications may require the assembly of any sections of elements anywhere inside the superstructure. Preferably the components of modules a positioned in their final location, to then form the final complete elements.

Completed as far as possible on the ground with minimal effort to connect the elements in the final location drastically reduces the immense task, by eliminating unnecessary steps, minimizing cost.

FIG. 8 is a close-up view of the crimping of an Element. The first half 51, or any arbitrary portion of such a part, can be joined with the second part 52 by preparing the parts, by arranging the pre crimped edges 53, then the joint surfaces are deformed to the finished crimp 54.

FIG. 9 is a side elevational view of a cover 65. It can be made of a flexible material for easy installation and serves as conduit, enhances the appearance, or closes gaps in the floors.

FIG. 10 is a close-up view of the joining of elements. Elements 50 can be firmly or elastically connected to adjacent elements or other components of the superstructure. The inter locker 71 and dampers 72 can easily be slid or placed into their final position, then any or all components can be pressurized, foamed or otherwise controlled to achieve the desired joining forces and other properties of the joint, elements 50, or any sector of the entire superstructure. The desired characteristics of every particular joint can be optimized to the specific geometric orientation, function, vibration absorption, noise dampening, and control other undesired effects such as disturbances generated by wind or thunderstorms.

Thus, a rapid deployment methodology is disclosed that enables an advanced, streamlined, economical and accelerated method of building architectures. While I have shown and described a specific description of the present invention, further modifications and improvements will occur to those skilled in the art. I desire it to be understood, therefore, that this invention is not limited to the particular form shown or described, and I intend in the appended claims to cover all modifications that do not depart from the spirit and scope of the invention.

What I claim is:

1. An advanced building method for architectures.

2. The advanced building method for architectures of claim 1, wherein the spatial elements, such as floors and walls, reinforce the structural integrity of the superstructure.

3. The advanced building method for architectures of claim 1, wherein the mass of the spatial elements is reduced.

4. The advanced building method for architectures of claim 1, wherein the spatial elements are produced more efficiently.

5. The advanced building method for architectures of claim 1, wherein the finished stories are completely installed in the final location more efficiently.

6. The advanced building method for architectures of claim 1, wherein the modular elements can be manufactured and/or assembled on site, even on ground level.

7. The advanced building method for architectures of claim 1, wherein partial or complete modular elements can be inserted into the framework.

8. The advanced building method for architectures of claim 1, wherein the building progress of all superstructural components can progress simultaneously.

9. The advanced building method for architectures of claim 1, wherein the spatial elements can be modules that can function as fire protection cells or firewalls.

10. The advanced building method for architectures of claim 1, wherein structural monitoring and warning systems can be utilized.

11. An advanced load lifting method for building architectures.

12. The advanced load lifting method for building architectures of claim 11, wherein load relay-lifters are utilized.

13. The advanced load lifting method for building architectures of claim 11, wherein heavier loads can be lifted.

14. The advanced load lifting method for building architectures of claim 11, wherein loads can be lifted more frequently.

15. The advanced load lifting method for building architectures of claim 11, wherein the load lifters can be utilized for future use of the completed architecture.

16. An advanced frame construction method for building architectures.

17. The advanced frame construction method for building architectures of claim 16, wherein an assisting structure climbs, easing the construction of the framework.

18. The advanced frame construction method for building architectures of claim 16, wherein the weight lifting capacity of the top cranes can be increased by improved support features.

19. The advanced frame construction method for building architectures of claim 16, wherein the loads of the top cranes can counterbalance each other.

20. The advanced frame construction method for building architectures of claim 16, wherein the assisting structure can be utilized for future use of the completed architecture.

21. The advanced frame construction method for building architectures of claim 16, wherein ironworkers benefit from additional safety potentials provided.
